(19) United States
(12) Patent Application Publication
(10) Pub. No.: US 2008/0019148 A1
(43) Pub. Date: Jan. 24, 2008

(54) Light source installation in a backlight module

(75) Inventor: Fang-I Chou, Yangmei Taoyuan (TW)

Correspondence Address: TROXELL LAW OFFICE PLLC, SUITE 1404, 5205 LEESBURG PIKE, FALLS CHURCH, VA, 22041, US

(73) Assignee: K-BRIDGE ELECTRONICS CO., LTD.

(21) Appl. No.: 11/699,070

(22) Filed: Jan. 29, 2007

(30) Foreign Application Priority Data
Jul. 19, 2006 (TW) 095212655

(51) Int. Cl. F21V 8/00

(52) U.S. Cl. 362/612

(57) ABSTRACT

A light source installation in a backlight module to solve the problem of developing darker and brighter bands found with the prior art includes a light emitting diode module disposed on one edge of a light guide plate; the light emitting diode module is comprised of multiple light emitting diodes; and any two neighboring light emitting diodes are alternatively arranged in a zigzag fashion, or a crossing point of the beams emitted by any two neighboring light emitting diodes at their maximal angles falls on where between the light guide plant and the light emitting diode module.

### BACKGROUND OF THE INVENTION

(a) Field of the Invention

The present invention is related to a light source installation in a backlight module, and more particularly, to one that is capable of effectively solving the problems of being vulnerable to produce darker and brighter bands spaced in between as found with the prior art.

(b) Description of the Prior Art

Whereas the construction of a liquid crystal display provides advantages of being light, thin, short, and small is comprehensively applied in modern information facilities including notebook, mobile phone, and PDA (Personal Digital Assistant), it needs a backlight module to realize its display function since a liquid crystal display does not emit light.

A backlight module of the prior art includes a light source and a light guide plate. Wherein, the light source is disposed in opposition to a light input surface of the light guide plate. The light guide leads the transmission direction of beams emitted from the light source by converting linear light source or point light source into plane light source to emit light. Multiple mesh points are distributed on the base of the light guide plate to fail the total reflection conditions of internal transmission of beams in the light guide and to diffuse the beams for promoting consistent beams outputted from the light guide plate, thus to further upgrade the general performance of the backlight module.

As illustrated in FIG. 1 of the accompanying drawings for a schematic view of a construction of a backlight module of the prior art, the backlight module is essentially comprised of a light-emitting diode module 20 disposed at an edge of a light guide plate 10; beams emitted from the LED (Light Emitting Diode) module 20 are inputted to the light guide plate 10 through the edge of the light guide plate 10 to convert the incoming beams in parallel from the LED module 20 into plane vertical light for eradiation to achieve the luminance performance results as expected.

The LED module 20 is comprised of multiple light emitting diodes 21. Whereas a specific range of light emitting angle of 30°˜130° is given to each LED 21 and the side of the light guide plate 10 in opposition to the LED 21 relates to a plane, beams emitted from the LED 21 are refracted by that side to enter into the light guide plate 10 and the scattering angle is further reduced to a maximal of approximately 120° so that the crossing point P of those beams emitted from any two neighboring light emitting diodes 21 falls on the light guide plate 10. As a result, a greater area of darker band 11 created on the light input side of the light guide plate 10 to reduce utility of beams, and further to affect luminance of a LCD of the backlight module and the consistence of the light outputted.

Therefore, an improved construction has been introduced to solve the problem of creating darker and brighter light bands. As illustrated in FIG. 2, multiple projections 12 are disposed on the light guide plate 10 in opposition to a light input surface of the LED 21 so that when beams emitted form the LED 21 are given wider scattering angle after refraction by each projection 12 to diminish the darker band. However, in this solution for diminishing darker band requires more processes and is vulnerable to increased NG (not good) rate since an additional process of the light guide plant is required for molding those projections.

### SUMMARY OF THE INVENTION

The primary purpose of the present invention is to provide a light source installation in a backlight module to solve the problem of developing darker and brighter bands found with the prior art. To achieve the purpose, a light source installation is essentially comprised of a light emitting diode module disposed on one edge of a light guide plate; wherein, the light emitting diode module is comprised of multiple light emitting diodes; and any two neighboring light emitting diodes are alternatively arranged in a zigzag fashion, or a crossing point of the beams emitted by any two neighboring light emitting diodes at their maximal angles falls on where between the light guide plant and the light emitting diode module.

### BRIEF DESCRIPTION OF THE DRAWINGS

FIG. 1 is a sectional view showing a construction of a backlight module of the prior art.

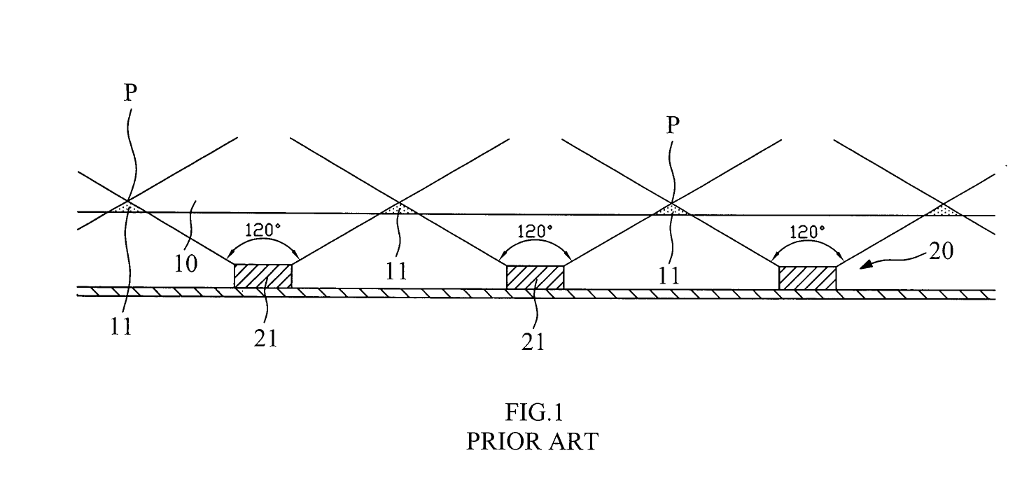

FIG. 2 is a sectional view showing a construction of another type of backlight module of the prior art.

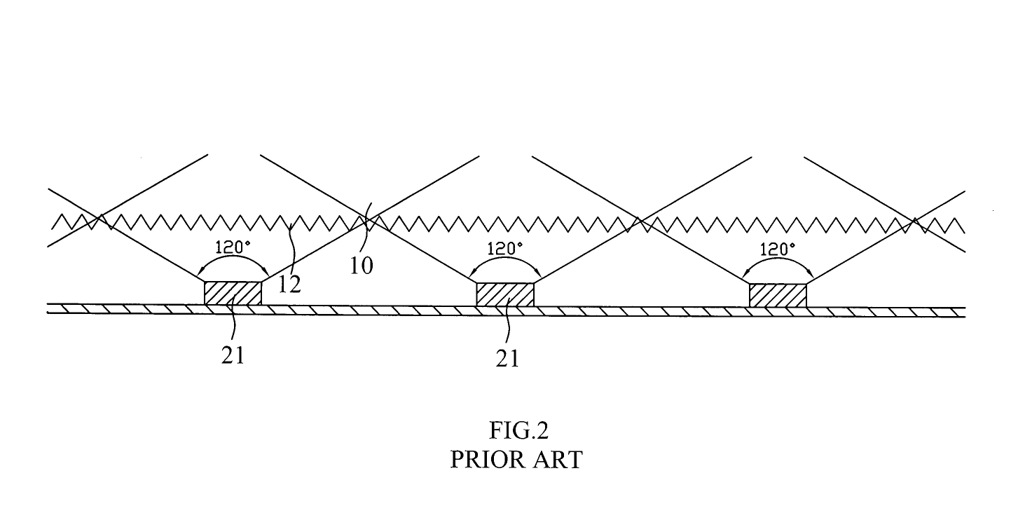

FIG. 3 is a sectional view of a backlight module of the present invention.

FIG. 4 is a magnified view of the backlight module of the present invention.

FIG. 5 is sectional view showing another construction of the backlight module of the present invention.

### DETAILED DESCRIPTION OF THE PREFERRED EMBODIMENTS

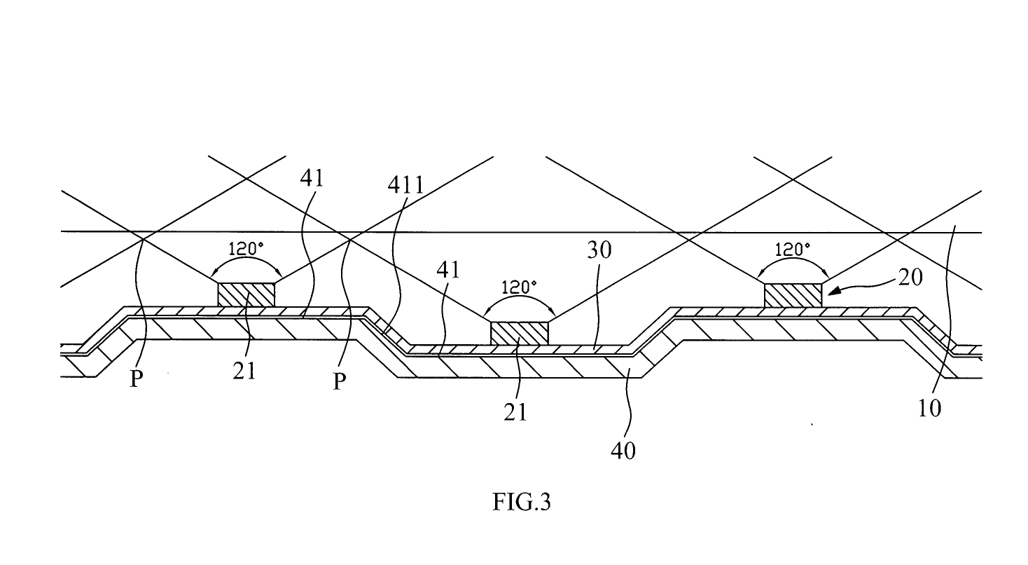

Referring to FIG. 3, a light source installation of an integral backlight module of the present invention is essentially comprised of a light emitting diode module 20 provided on one edge of a light guild plate 10 to guide beams emitted from the light emitting diode module 20 into the light guide plate 10 through the edge of the light guide plate 20, thus to convert the parallel light inputted from the light emitting diode module 20 into vertical light on a plane for outputting to achieve the luminance performance results as expected.

The light emitting diode module 20 is comprised of multiple light emitting diodes 21; and any two neighboring light emitting diodes 21 are alternatively arranged in a zigzag fashion. As illustrated in FIG. 3, a preferred embodiment of the present invention has all the light emitting diodes arranged on a flexible circuit board 30; the light emitting diode module 20 and the flexible circuit board 30 are secured on a locating member 40 (e.g., a plastic frame); multiple locating portions 41 are alternatively arranged in a zigzag fashion on the locating member 40; and any two neighboring locating portions are abutted to each other by means of a slope 411.

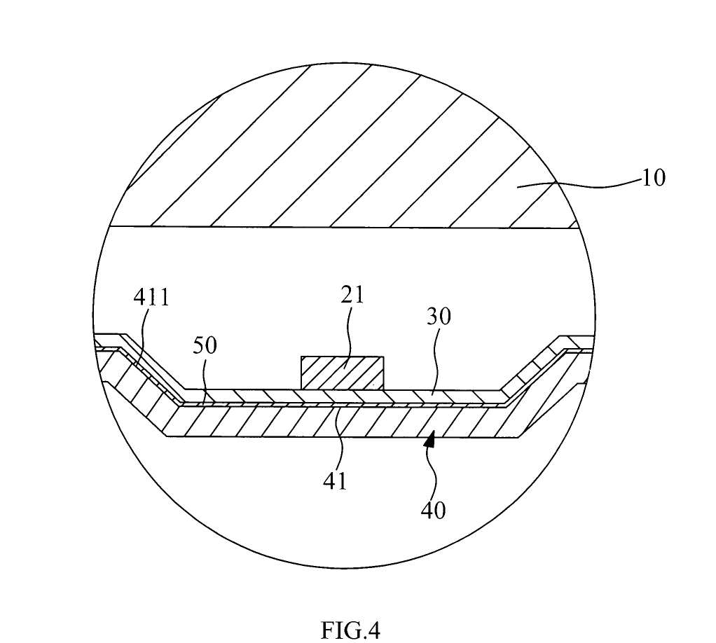

To assemble, an adhesive 50 is first applied at where between the flexible circuit board 30 and the locating member 40 as illustrated in FIG. 4 so that the flexible circuit board 30 is assembled in position to the locating member 40 depending on the positions of those locating portions 41 alternatively at different levels. Accordingly, when each light emitting diode 21 is secured to its respective locating portion 41, any two neighboring light emitting diodes 21 are alternatively arranged in a zigzag fashion. Once the beams emitted from each light emitting diode 21 enter into the light guide plate 10, a crossing point P of beams emitted from each pair of abutted light emitting diodes 21 at their maximal angles as illustrated in FIG. 3 merely falls at where between the light guide plate 10 and the light emitting diode module 20 to effectively eliminate the phenomenon of darker and brighter bands.

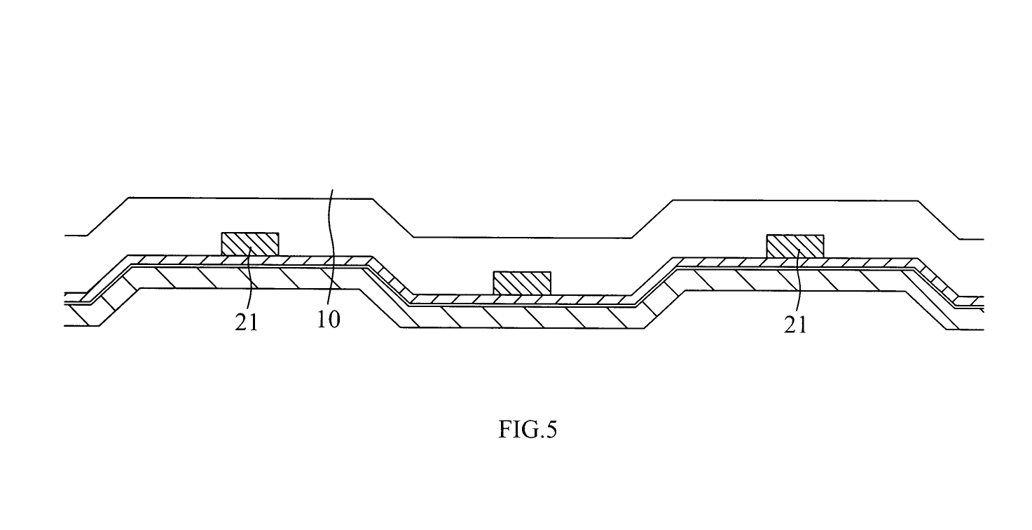

Furthermore, one side of the light guide plate 10 closer to the light emitting diode module 20 is made in a platform structure as illustrated in FIGS. 3 and 4; or in the alternatively zigzag structure as illustrated in FIG. 5 and all the light emitting diodes 21 are alternatively arranged in zigzag fashion by compromising the light guide plate 10 to achieve the same purpose of effective elimination of the phenomenon of darker and brighter bands.

The prevent invention provides an improved structure of a light source of backlight module, and the application for a utility patent is duly filed accordingly. However, it is to be noted that the preferred embodiments disclosed in the specification and the accompanying drawings are not limiting the present invention; and that any construction, installation, or characteristics that is same or similar to that of the present invention should fall within the scope of the purposes and claims of the present invention.

I claim:

1. A light source installation in a backlight module including a light guide plate and a light emitting diode module comprised of multiple light emitting diodes; the light emitting diode being disposed on one edge of the light guide board; and any two neighboring light emitting diodes being alternatively arranged in a zigzag fashion.

2. The light source installation in a backlight module as claimed in claim 1, wherein all the light emitting diodes are laid on a flexible circuit board; both of the light emitting diode module and the flexible circuit board are secured to a locating member; multiple locating portions being alternatively formed in a zigzag fashion on the locating member; and the flexible circuit board is assembled and secured to the locating member by compromising those locating portions.

3. A light source installation in a backlight module including a light guide plate and a light emitting diode module comprised of multiple light emitting diodes; the light emitting diode module being located at one edge of the light guide plate; a crossing point of beams emitting from any pair of neighboring light emitting diodes at their maximal angles falls at where between the light guide plate and the light emitting diode module.

4. The light source installation in a backlight module as claimed in claim 3, wherein all the light emitting diodes are laid on a flexible circuit board; both of the light emitting diode module and the flexible circuit board are secured to a locating member; multiple locating portions being alternatively formed in a zigzag fashion on the locating member; and the flexible circuit board is assembled and secured to the locating member by compromising those locating portions.

5. A light source installation in a backlight module including a light guide plate and a light emitting diode module comprised of multiple light emitting diodes; one side of the light guide plate closer to the light emitting diode module is formed in a zigzag structure at different levels; and those light emitting diodes are alternatively arranged in zigzag fashion at different levels by compromising the light guide plate.

6. The light source installation in a backlight module as claimed in claim 5, wherein all the light emitting diodes are laid on a flexible circuit board; both of the light emitting diode module and the flexible circuit board are secured to a locating member; multiple locating portions being alternatively formed in a zigzag fashion on the locating member; and the flexible circuit board is assembled and secured to the locating member by compromising those locating portions.

7. The light source installation in a backlight module as claimed in claim 6, wherein the locating member relates to a plastic frame.

8. The light source installation in a backlight module as claimed in claim 6, wherein an adhesive is applied between the flexible circuit board and the locating member.

9. The light source installation in a backlight module as claimed in claim 6, wherein any two neighboring locating portions are abutted to each other by means of a slope.

10. The light source installation in a backlight module as claimed in claim 6, wherein one side of the light guide plate closer to the light emitting diode module is related to a structure of a platform.

11. The light source installation in a backlight module as claimed in claim 6, wherein one side of the light guide plate closer to the light emitting diode module is made in an alternatively zigzag structure at different levels; and those light emitting diodes are alternatively arranged at different levels by compromising the zigzag structure of the light guide plate.
